(19) United States
(12) Patent Application Publication
(10) Pub. No.: US 2011/0258302 A1
(43) Pub. Date: Oct. 20, 2011

(54) System And Method For Remotely Determining Identification And Physical Location Of Equipment In A Rack

(75) Inventors: David Alan Cole, St. Louis, MO (US); James Ward Goddard, Ballwin, MO (US); Christopher Young, Wildwood, MO (US)

(73) Assignee: No Limits Software, LLC

(21) Appl. No.: 12/763,350

(22) Filed: Apr. 20, 2010

(51) Int. Cl. G06F 15/173; G06F 17/30

(52) U.S. Cl. 709/223; 707/769; 707/E17.014

(57) ABSTRACT

A system and method for uniquely identifying computer and support infrastructure equipment in a rack and to determine the physical location of the equipment within the rack. In one embodiment, a set of communication ports is installed in the rack, with each communication port representing a physical rack location unit. The equipment is queried via the equipment's communication port, which is coupled to one of the communication ports in the rack. Equipment which does not support identification through some protocol has its identification information stored in an intelligent device which can be queried through the same set of communication ports. A management module collects the equipment information and location and aggregates the information for the entire rack. This information can then be queried by a remotely over the network.

### BACKGROUND

Computer servers, storage equipment and network equipment such as routers, switches, and hubs are becoming increasingly important to large enterprises to process, store and retrieve data, provide e-commerce functions, to provide a presence via a company web site, host web-based or local applications and otherwise execute a wide variety of tasks. As such, large enterprises may have hundreds or even thousands of racks of information technology (IT) equipment comprising hundreds or thousands of servers, storage devices, and network equipment as well as support infrastructure such as power distribution units, uninterruptible power supplies, transfer switches and other equipment. These racks of equipment may be contained in one computer room or spread across multiple rooms in multiple buildings throughout the world.

When a piece of IT equipment fails, the usual goal is to restore the equipment to full functionality as quickly as possible. One of the first steps in troubleshooting IT equipment is to physically locate the equipment. This can be very difficult to do in many cases, sometimes taking more than a day to simply locate the device. A standard IT rack can store up to 42 servers and may also contain other equipment, so it is important to know the exact position of the failed equipment within the rack.

Many companies employ an IT asset management system to store detailed information about IT equipment and its location. One issue frequently encountered with these systems is the cost and time to initially define and locate the equipment within the data center. It can take many months to perform the initial setup of the equipment within the repository. A second issue is the inability of previous IT asset management systems to perform any type of automatic or remote auditing of the equipment once it has been entered into the repository. Even with a sophisticated work flow process to handle additions, deletions and changes to the equipment, it is possible that equipment has been moved from the location indicated by the repository. This inability of a system to perform an automatic audit is compounded by the fact that a full audit can take almost as long to accomplish as the initial setup.

### SUMMARY OF THE INVENTION

The present system and method is used to automatically identify a unique piece of information technology equipment and its physical location within computer racks. The system enables users to identify the IT equipment within a computer rack, including unique identification information such as a global unique identifier (GUID), a Media Access Control (MAC) address, a serial number or other such unique identification, as well as the physical location within the rack. For IT equipment which provides identification through a communications interface, such as an Intelligent Platform Management Interface (IPMI) communications port or via the local or wide area network using a protocol such as Simple Network Management Protocol (SNMP), the system directly queries the IT equipment for its identification. For IT equipment that does not easily provide unique identification information via a communications interface, the present method includes the use of a small identification device that can be affixed to the IT equipment. The identification device provides the ability to store unique identification information for the IT equipment. This information is written to the identification device and stored for later retrieval. The combination of these two methods of identification—directly from the device or from the identification device affixed to the equipment—can provide unique identification for all of the IT equipment. The system determines the physical location of the IT equipment based on the port into which the IT equipment or identification device is connected using a data communications cable.

### BRIEF DESCRIPTION OF THE DRAWINGS

FIG. 1 is a diagram illustrating a rack of IT equipment in accordance with the present invention.

FIG. 2 is an expanded view of a rack of IT equipment illustrating how the individual pieces of equipment are connected to the communication ports contained within the housing.

FIG. 3 is a flow chart of the communication process used by the management module to retrieve identification and location information from the IT equipment.

FIG. 4 is a block diagram illustrating an overall system to retrieve information from each of the management modules.

FIG. 5 is a diagram illustrating commands from the management module to external systems.

FIG. 6 is a diagram illustrating one possible network ID packet, in accordance with the present invention.

### DETAILED DESCRIPTION

The present system comprises a combination of hardware, software and firmware to determine the IT equipment identification and physical location of equipment within one or more racks of computer equipment and communicating this equipment identification and location to remote users or computer software applications. In the following description numerous specific details are set forth to provide a thorough understanding of embodiments of the invention. One skilled in the relevant art will recognize, however, that the invention can be practiced without one or more of the specific details, or with other methods, components, materials, etc.

Typically, IT equipment in a computer rack is mounted onto the rack rails in such a way as to occupy one or more rack units (a rack unit is 1.75 inches in height). This IT equipment includes computer servers, network switches, network routers, network hubs, storage equipment, uninterruptible power supplies, static transfer switches and other devices. A standard computer rack has space available for 42 rack units although other rack sizes are also available. While most equipment in a rack is mounted to the rack rails and occupies one or more rack units, some equipment is mounted in such a manner that it does not occupy a rack unit. These devices are sometimes referred to as ‘zero-U’ devices because they occupy no rack units.

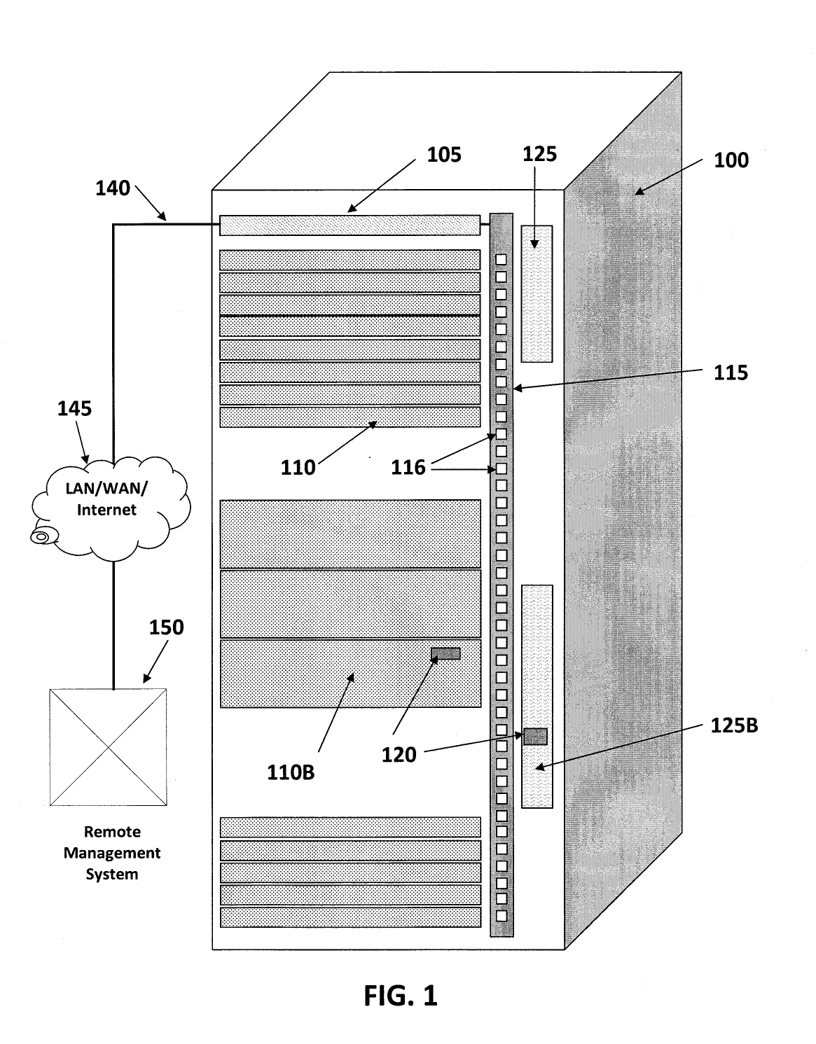

FIG. 1 is a diagram illustrating the IT identification and location system 50 which includes a management module 105, a housing 115 which contains multiple data communications ports 116, an identification device 120 and a network communications cable 140.

Identification device 120 is a small electronic device which stores identification information such as manufacturer, model, serial number, a GUID or other information that can be used to uniquely identify IT equipment in a rack. The identification device 120 is permanently attached to IT equipment to uniquely identify the equipment. The identification device 120 connects to the data communication port 116 using a data communications cable 130B. The management module 105 can write information to the identification device 120 for storage. The management module 105 can read information stored on the identification device 120.

Typically, the management module 105 is an independent hardware module with dedicated firmware to perform management functions, such as but not limited to, identifying the rack-mounted identifiable IT equipment 110, the zero-U identifiable IT equipment 125 or the identification device 120 connected to one of the data communication ports 116, identifying that equipment has been added, removed, or moved, and logging system errors. In one embodiment, the location information and instruction set is stored on the management module 105 in a flash memory device. In other embodiments, the management module 105 includes any one of read only memory (ROM), programmable ROM, electrically erasable programmable ROM, or the like. In one embodiment, system memory includes random access memory (RAM). In one embodiment, the management module 105 contains one or more or an integrated drive electronic (IDE) hard disk, an enhanced IDE (EIDE) hard disk, a redundant array of independent disks (RAID), a small computer system interface (SCSI) hard disk, or the like. Further, the management module 105 has a known internet protocol (“IP”) address which can be accessed by a remote management system 150 via the LAN/WAN/Internet network 145. A remote user (e.g. data center technician) can communicate with the management module 105 via the LAN/WAN/Internet network 145. The management module 105 may contain other components such as environmental sensors, digital inputs, digital outputs or analog inputs and performs other functions such as temperature or power monitoring as well as performing the functions associated with the identification and location of the equipment within the computer rack 100.

The management module 105 can also be a software application or service running on a computer server within the computer rack 100 and performing management functions, such as but not limited to, identifying the rack-mounted identifiable IT equipment 110, the zero-U identifiable IT equipment 125 or the identification device 120 connected to one of the data communication ports 116, identifying that IT equipment has been added, removed, or moved, and logging system errors. In one embodiment, the management module 105 contains one or more or an integrated drive electronic (IDE) hard disk, an enhanced IDE (EIDE) hard disk, a redundant array of independent disks (RAID), a small computer system interface (SCSI) hard disk, or the like. Further, the management module 105 has a known internet protocol (“IP”) address which can be accessed by a remote management system 150 via the LAN/WAN/Internet network 145. A remote user (e.g. data center technician) can communicate with the management module 105 via the LAN/WAN/Internet network 145.

For the purposes of this description, four categories of IT equipment are defined:

(1) rack-mounted identifiable IT equipment 110

(2) rack-mounted non-identifiable IT equipment 1108

(3) zero-U identifiable IT equipment 125

(4) zero-U non-identifiable IT equipment 125B

The rack-mounted identifiable IT equipment 110 has support for one of the following communication protocols: IPMI, IBM Remote Supervisor Adapter (RSA), Hewlett-Packard integrated LightsOut (iLO), Sun Advanced Lights Out Manager (ALOM), Dell Remote Access Controller (DRAC), or some other protocol for providing identification information to an external system such as the management module 105. The external system will query the IT equipment using one or more of these protocols to uniquely identify the equipment. The identification information can include, but is not limited to, a GUID, a MAC address, manufacturer, model and serial number. The rack-mounted non-identifiable IT equipment 110B does not support one of the aforementioned communication protocols.

For the rack-mounted non-identifiable IT equipment 110B, the identification device 120 is attached. The identification device 120 provides identification information to the management module 105. The identification information can include, but is not limited to, a GUID, a MAC address, manufacturer, model and serial number.

The management module 105 is connected to a LAN/WAN/Internet network 145 (Local Area Network/Wide Area Network/Internet) using the network communications cable 140. A remote management system 150 can communicate with the management module 105 over the LAN/WAN/Internet network 145. In another embodiment, a remote user can communicate with the management module 105 over the LAN/WAN/Internet network 145.

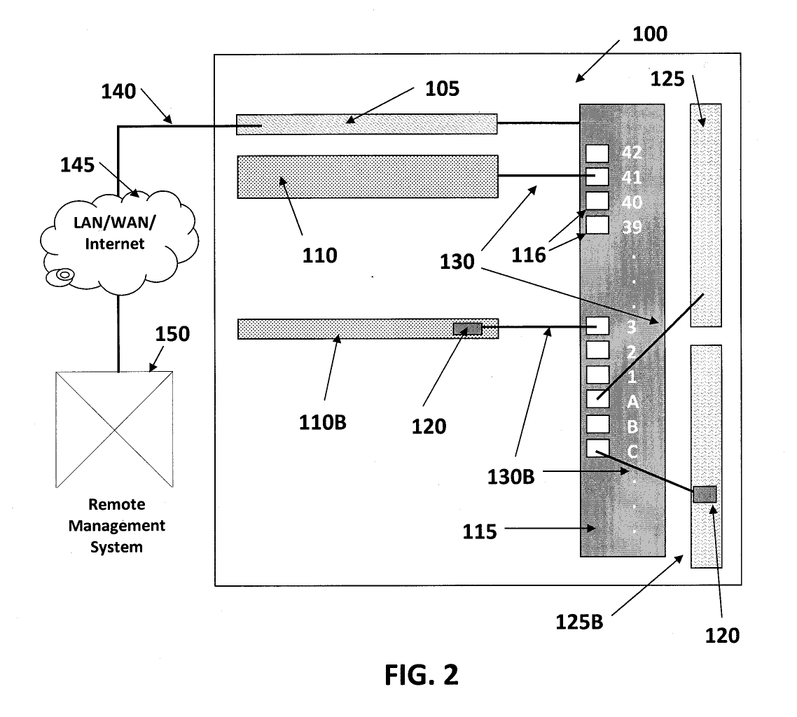

FIG. 2 is a partially expanded view of FIG. 1 illustrating the computer rack 100 in accordance with the present invention. The illustrated embodiment includes the management module 105, the rack-mounted identifiable IT equipment 110, the rack-mounted non-identifiable IT equipment 110B, the zero-U identifiable IT equipment 125, the zero-U non-identifiable IT equipment 125B, the data communications ports 116 in the housing 115, the identification device 120, the data communication cables 130 for communication with the identifiable IT equipment 110, the data communications cables 130B for communication with the identification device 120, the network communications cable 140, the LAN/WAN/Internet network 145, and the remote management system 150.

In an exemplary embodiment, the components are interconnected as follows. The management module 105 is connected to the LAN/WAN/Internet network 145 using the network communications cable 140. The management module 105 also has a connection to the housing 115. This provides a communications path to each of the data communications ports 116 contained in the housing 115. In another embodiment, the management module 105 may connect to multiple housings 115.

The rack-mounted identifiable IT equipment 110 is connected via the data communications cable 130 to the data communication port 116 corresponding to the top rack unit occupied by the rack-mounted identifiable IT equipment 110, thus identifying its physical location within the computer rack 100. This connection then provides a communication path to the management module 105, allowing the management module 105 to communicate with the rack-mounted identifiable IT equipment 110 in such a way as to retrieve identification information.

For the rack-mounted non-identifiable IT equipment 110B, the identification device 120 is attached to the rack-mounted non-identifiable IT equipment 110B in a permanent manner and is connected via the data communications cable 130B to the data communication port 116 corresponding to the top rack unit occupied by the rack-mounted non-identifiable IT equipment 110B, thus identifying its physical location within the computer rack 100. This connection then provides a communication path to the management module 105, allowing the management module 105 to communicate with the identification device 120 in such a way as to retrieve identification information from or send identification information to the identification device 120. In other embodiments the identification device 120 is attached to the rack-mounted non-identifiable IT equipment 110B in a semi-permanent or a temporary manner.

The zero-U identifiable IT equipment 125 is connected via the data communications cable 130 to one of the data communication ports 116 indicating a zero-U device, thus identifying that the device is a zero-U device in the computer rack 100. This connection then provides a communication path to the management module 105, allowing the management module 105 to communicate with the zero-U identifiable IT equipment 125 in such a way as to retrieve identification information.

For the zero-U non-identifiable IT equipment 125B, the identification device 120 is attached to the zero-U non-identifiable IT equipment 125B in a permanent manner and is connected via a data communications cable 130B to one of the data communication ports 116 indicating a zero-U device, thus identifying that the device is a zero-U device in the computer rack 100. This connection then provides a communication path to the management module 105, allowing the management module 105 to communicate with the identification device 120 in such a way as to retrieve identification information from or send identification information to the identification device 120. In other embodiments the identification device 120 is attached to the zero-U non-identifiable IT equipment 125B in a semi-permanent or a temporary manner.

The data communication ports 116 are arranged in the housing 115 in a vertical manner in a zero-U device so as to align the data communication ports 116 with the rack location units throughout the height of the computer rack 100. In another embodiment, the data communication ports 116 are arranged in a rack-mountable housing 115 with port designations indicating the rack location unit. Other possible embodiments include various other configurations for arranging the data communication ports 116 within the housing 115.

The data communication port 116 is typically an RJ45 serial port. In another embodiment, the data communication port 116 is a DB9 serial port. In other embodiments the data communication port 116 is another serial port type. In other embodiments the data communication port 116 supports other types of communication, including but not limited to network communication, USB communication, I²C communication, or 1-wire communication.

It should be appreciated that various other elements of the management module 105, the data communication ports 116 and the housing 115 have been excluded from FIG. 1 and FIG. 2 and this discussion for the purposes of clarity. For example, data communication wiring between the management module 105 and the individual communication ports 116 may be done with subcomponents to reduce the number of individual wires. In another example, the management module 105 and the housing 115 may be combined into a single unit. Furthermore, the illustrated embodiment shown in FIG. 1 and FIG. 2 illustrate only one possible configuration of the components. One of ordinary skill in the art having the benefit of the present disclosure will understand that various modifications to the architecture may be implemented.

In use, the management module 105 will be mounted in the rack 100 and powered by connecting the power cable to a power source. The network communications cable 140 will be connected between the management module 105 and a router or switch so as to provide network connectivity to the LAN/WAN/Internet network 145. The housing 115 will be mounted in the rack 100 so that the communication ports 116 are aligned with the position of the rack location units within the rack 100. The communications cable 130 will be connected between the rack-mounted identifiable IT equipment 110 and the communication port 116 identifying its position within the rack 100. The communications cable 130 will be connected between the zero-U identifiable IT equipment 125 and the communication port 116 identifying that it is a zero-U device within the rack 100. The identification device 120 will be attached to the rack-mounted non-identifiable IT equipment 110B. The communications cable 130B will be connected between the identification device 120 and the communication port 116 identifying the position of the rack-mounted non-identifiable IT equipment 110B within the rack 100. The identification device 120 will be attached to the zero-U non-identifiable IT equipment 125B. The communications cable 130B will be connected between the identification device 120 and the communication port 116 identifying that it is a zero-U device within the rack 100.

The management module 105 will communicate with each of the communication ports 116 in a round-robin fashion, querying each connection to determine the unique identity of each piece of IT equipment connected to the port. In some cases, the equipment will be uniquely identified by querying the identification device 120 attached to the equipment. The location of the equipment will be determined by which communication port 116 is used to communicate with the equipment or identification device 120. The unique identity and location of each piece of IT equipment will be stored in the management module 105. A remote user or management system can query the management module 105 for this identification and location information.

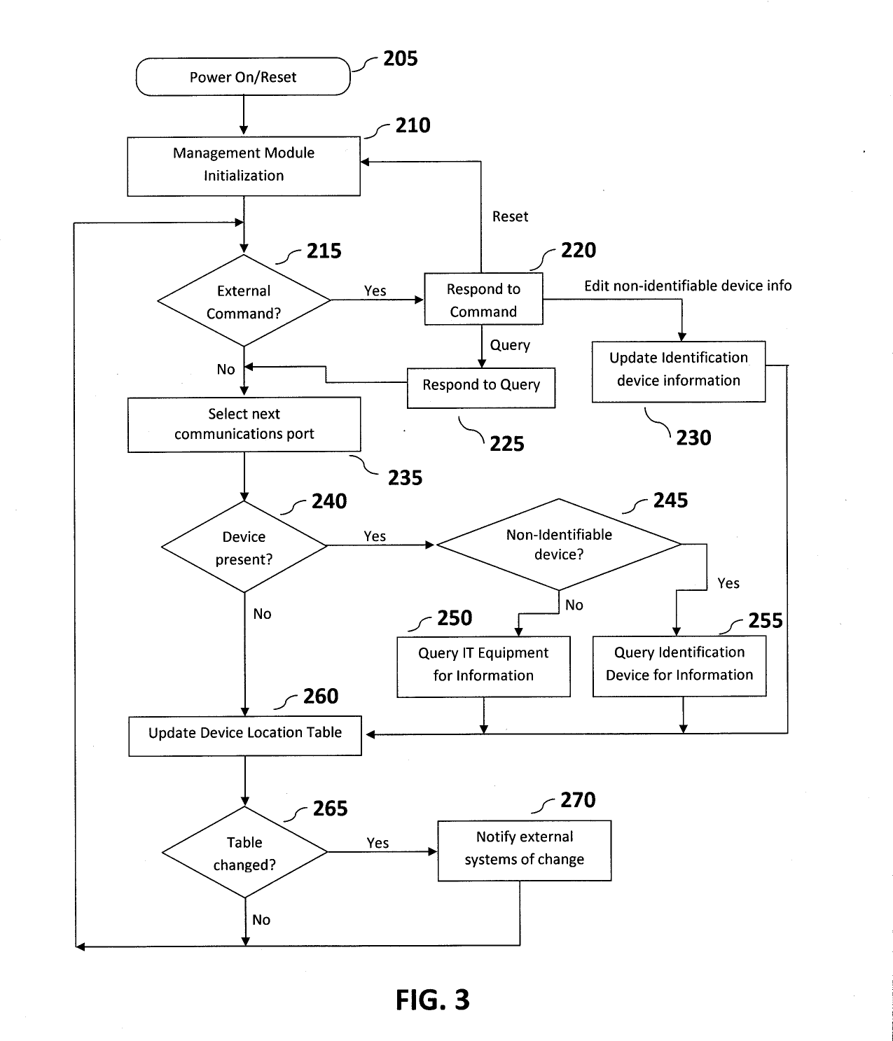

FIG. 3 is a flowchart illustrating a process for identifying device information and location, storing this information, and responding to queries and commands from a remote user or the remote management system 150, in accordance with the present invention.

In a process block 205, the management module 105 is powered on, power cycled or otherwise reset. In a process block 210, once power is delivered to the management module 105, the management module 105 performs an initialization process. This may include hardware discovery and initialization (e.g., discovering and initializing memory, power on self-test, installing network interface driver, and other system load activities).

In a decision block 215, it is determined whether there is an external command present. If it is determined that an external command is present, a process block 220 is executed to respond to the command. If the command is invalid, a not-acknowledged (NAK) message will be sent to the external system indicating an invalid command. The process will then flow to a process block 235. If the command is a reset command, the management module 105 will be reinitialized in the process block 210. If the command is a query, the management module 105 will respond to the command in a process block 225. Following the processing of the query, the process then flows to the process block 235. If the command is a request to edit non-identifiable device information, the identification device 120 information will be updated in a process block 230, with the process then flowing to a process block 260.

In the process block 230, the management module 105 transmits the device information (device ID, device manufacturer and device model) to the identification device 120 connected to the communication port 116 defined by the rack unit information provided as part of the command. If the identification device 120 is not connected to the communication port 116, a NAK message will be sent indicating there was a problem in setting the information. If the identification device 120 is connected to the port, the device identification information on the identification device 120 will be overwritten with the new information passed with the command.

In the process block 235, the communication port 116 will be selected and processing will flow to a decision block 240. The communication port 116 will be selected in a round-robin fashion beginning with port 1 and proceeding to the next port until there are no further ports, at which time port 1 will be selected again.

In the decision block 240, it is determined whether there is a device connected to the port selected in the process block 235. If there is not, the process then flows to the process block 260. If a device is connected, process flows to a decision block 245. In the decision block 245, it is determined if the connected device is an identifiable or non-identifiable device. If it is the rack-mounted identifiable device 110 or it is the zero-U identifiable device 125, processing flows to a processing block 250, where the management module 105 will query for device identification information. If it is the rack-mounted non-identifiable device 110B or the zero-U non-identifiable device 125B, processing flows to a processing block 255, where the management module 105 will query the identification device 120 for device identification information.

In the processing block 260, the device location table is updated. If it was determined that there was no device present in the decision block 240, the device information will be set to null values. If it was determined that there was a device present, the device information will be updated with either the information from the device itself or the identification device 120. In any of the cases, if the device information changed, a flag will be set indicating that the device information has been updated. In a decision block 265, it is determined whether the device information has been updated. If it has not, processing flows back to the decision block 215. If it has, a processing block 270 is executed and a message is sent with change notification. Following the transmission of the message, processing then flows back to the decision block 215.

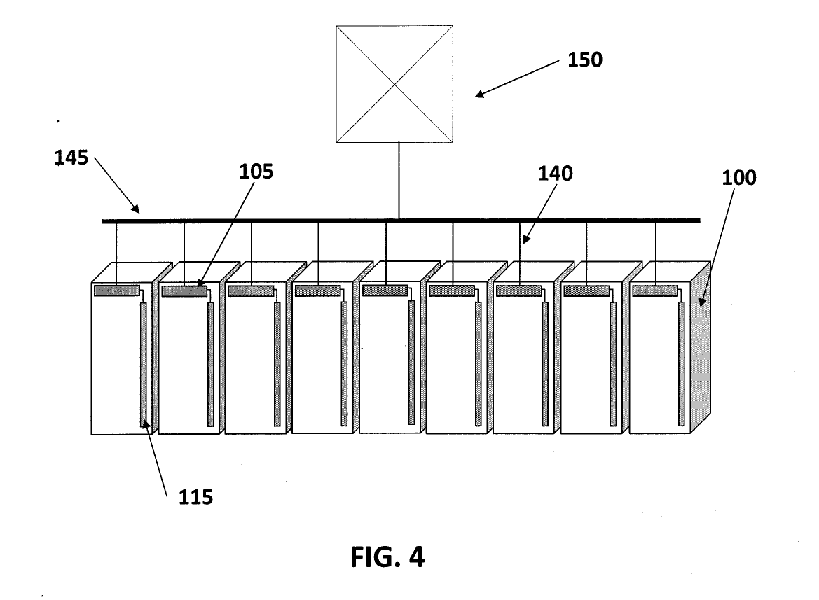

FIG. 4 is a diagram illustrating multiple computer racks 100, each containing the management module 105 and the housing 115 containing multiple communication ports 116. FIG. 4 depicts an overall management system that may be used to show the location/identification of any piece of IT equipment in a data center. The management module gathers this information for one rack. The overall system provides a single location for all of this data across multiple racks. The management module 105 is connected to the LAN/WAN/Internet network 145 via the network communication cable 140. The remote management system 150 is also connected to the LAN/WAN/Internet network 145. In another embodiment, the management module 105 may connect to multiple housings 115 containing sets of communication ports 116.

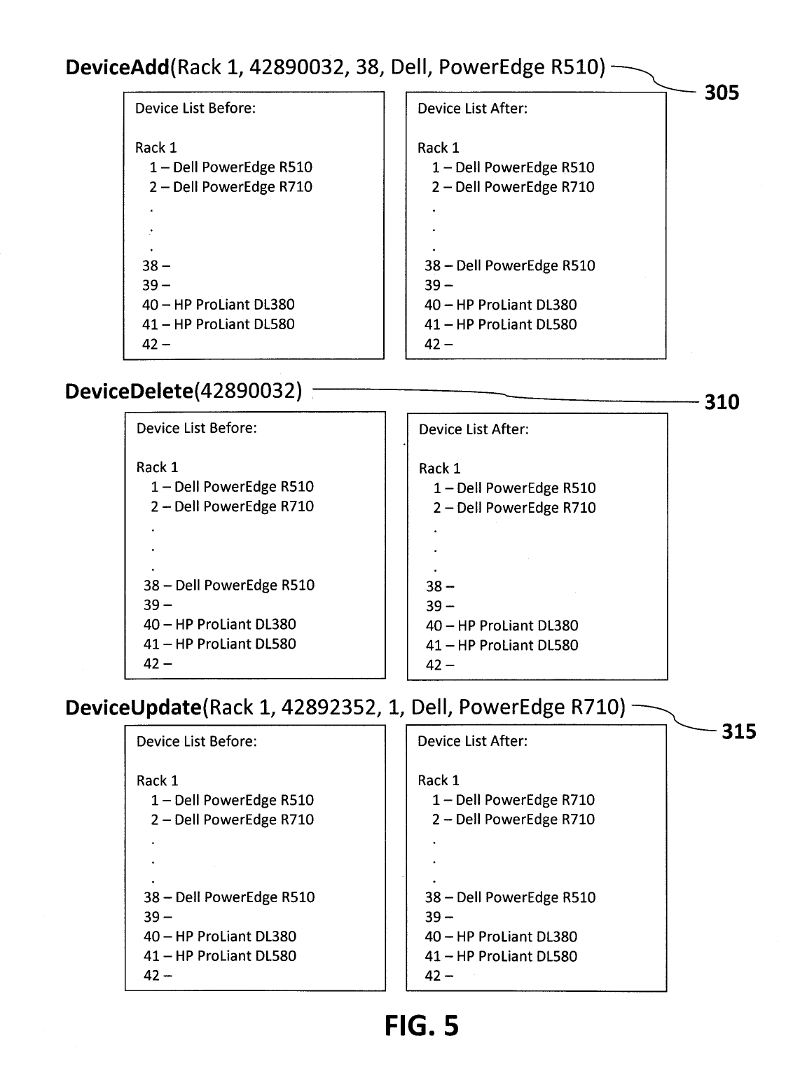

FIG. 5 illustrates three exemplary message formats that may be sent between the management module 105 and the remote management system. A DeviceAdd message 305 is sent from the management module 105 to the remote management system to indicate that a new device was added to the rack. The DeviceAdd message 305 includes the rack ID, the device ID, the rack unit, the device manufacturer and the device model. This information may be used to add the device to a master device list. A DeviceDelete message 310 is sent from the management module 105 to the remote management system to indicate that a device has been deleted from the rack. The DeviceDelete message 310 includes the device ID. This information may be used to remove the appropriate device from a master device list. A DeviceUpdate message 315 is sent from the management module 105 to the remote management system to indicate that information about a device has been changed. The DeviceUpdate message 315 includes the rack ID, the device ID, the rack unit, the device manufacturer and the device model. This information may be used to modify a device in a master device list. The DeviceUpdate message 315 is sent from the remote management system to the management module 105 to indicate that information on the identification device 120 is to be modified. This allows the remote management system to remotely update the information on the identification device 120.

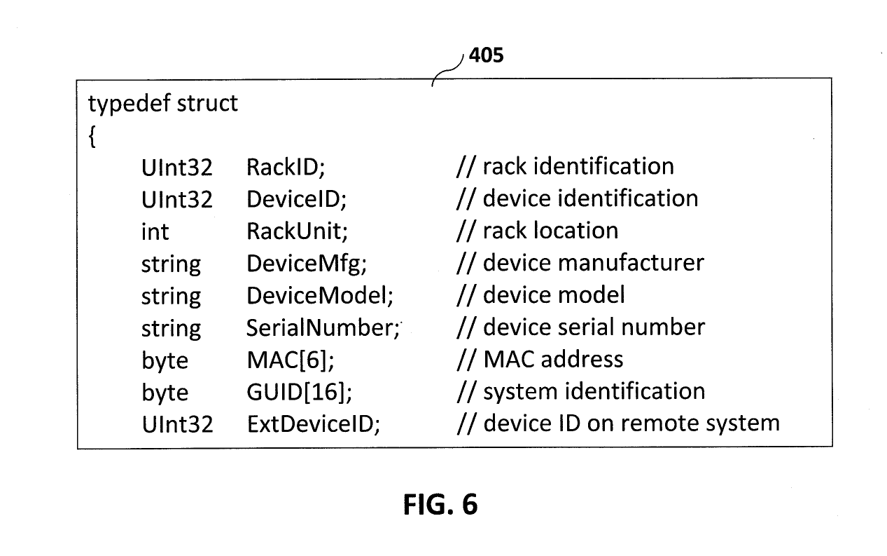

FIG. 6 illustrates an exemplary embodiment of the identification packet 405. Each device entry in the device list contains information such as that defined in the identification packet 405. The remote management system can query the management module 105 for information about the equipment located in the rack. The management module 105 responds to a general query such as “send the list of devices in rack” by sending the identification packet 405 for each piece of equipment in the rack. The management module 105 can also respond to a more specific query such as “send detailed device information for the equipment located in rack location 23” by sending the identification packet 405 for the specific equipment in that rack location or by responding that there is no equipment located in that rack location.

Various equivalent modifications are possible within the scope of the invention, as those skilled in the relevant art will recognize. These modifications can be made to the embodiments described herein in light of the above detailed description. For example, the management module 105 may contain other components such as environmental sensors, digital inputs, digital outputs or analog inputs and perform other functions such as temperature or power monitoring as well as performing the functions associated with the identification and location of the equipment within the rack.

The above description of illustrated embodiments of the invention, including what is described in the Abstract, is not intended to be exhaustive or to limit the invention to the precise forms disclosed. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system for remotely identifying and locating a specific piece of equipment in a computer rack, the system comprising:
a management module; and
a set of communication ports, each of which couple the management module with a respective piece of the equipment;
wherein the management module is coupled, via a network, with a remote application that queries the management module to uniquely identify each piece of the equipment and the physical location thereof within the rack.

2. The system of claim 1 wherein the physical location of a specific piece of the equipment within the rack is determined by the communications port used to connect the specific piece of equipment to the management module.

3. The system of claim 1, wherein the management module sends a device identification packet over the network to the remote application in response to a request, via the network, for the unique identification and physical location of each piece of the equipment in the rack.

4. The system of claim 1, wherein the management module responds to a query for a list of devices in the rack by sending an identification packet, identifying each piece of equipment in the rack, to the remote application.

5. The system of claim 4, wherein:
the device identification packet is shared with other management modules of other racks of equipment; and
a master list containing said identification packets is generated for multiple racks of the equipment.

6. The system of claim 1, wherein the management module responds to a query for device information for the equipment located in a particular rack location by sending an identification packet, identifying the specific equipment in the particular rack location, to the remote application.

7. A system for remotely identifying and locating a specific piece of equipment in a computer rack, the system comprising:
an identification device in which is stored device identification information uniquely identifying the specific piece of equipment, for each piece of equipment in the rack;
a management module responsive to queries for identifying each piece of the equipment and the location thereof within the rack; and
a plurality of communications ports, each coupled to a respective said identification device and to the management module, wherein the location of a specific piece of the equipment within the rack is determined by the communications port used to connect the specific piece of equipment to the management module;
wherein the management module retrieves the device identification information from the identification device to identify non-identifiable pieces of the equipment that do not support direct identification.

8. The system of claim 7, wherein the management module generates a network ID packet, containing the device identification information, over a network to a remote requester in response to a request, via the network, for the physical location of the equipment.

9. The system of claim 8, wherein the network ID packet identifies each piece of equipment in the rack.

10. The system of claim 8, wherein the network ID packet identifies the equipment located in a particular rack location by sending an identification packet, identifying the specific equipment in the particular rack location.

11. The system of claim 8, wherein:
the network ID packet is shared with other management modules for other racks of equipment; and
a master list containing a plurality of said network ID packets is generated for multiple racks of the equipment.

12. The system of claim 7 wherein the management module receives a network ID packet, containing the device identification information, over a network from a remote requester, via the network, and the management module then stores the device identification information into the identification device.

13. A method for remotely identifying and locating equipment in a computer rack comprising:
receiving, via a communications network, detailed equipment information for each type of equipment in the rack;
creating a list including (1) a unique equipment identifier with information indicating the location of the corresponding equipment in each rack, and (2) corresponding said detailed equipment information received via the network; and
querying the list via the communications network to provide the identity of each piece of equipment in the rack and the corresponding detailed equipment information.

14. The method of claim 13, wherein the list is queried to provide the location of a specific piece of equipment in the rack.

15. A method for remotely identifying and locating a specific piece of equipment in a computer rack comprising:
coupling an identification device in which a unique identifier is stored, to each of a plurality of pieces of the equipment in the rack;
collecting unique identification information for each of the pieces of equipment in the rack using a bar code reader;
collecting the unique identifier stored in the identification device for each of the pieces of equipment in the rack using a bar code reader;
storing the unique identifier and the unique identification information, for each of the pieces of equipment in the rack, in a respective storage device coupled to each of the pieces of equipment; and
querying the identification device via an external system to determine the identity and location of the specific piece of equipment in the rack.

16. The method of claim 15, including storing additional equipment information in the storage device via the external system.
